(19) United States
(12) Patent Application Publication
(10) Pub. No.: US 2011/0013793 A1
(43) Pub. Date: Jan. 20, 2011

(54) VOLUME ADJUSTER AND HEARING AID WITH VOLUME ADJUSTER

(75) Inventors: HARALD KLEMENZ, FURTH (DE); PEI CHYI KRISTY LIM, SINGAPORE (SG)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., SINGAPORE (SG)

(21) Appl. No.: 12/837,699

(22) Filed: Jul. 16, 2010

(30) Foreign Application Priority Data
Jul. 16, 2009 (DE) 10 2009 033 448.3

(51) Int. Cl. H04R 25/00

(52) U.S. Cl. 381/321

(57) ABSTRACT

A manually-actuatable volume adjuster for a hearing aid and a hearing aid with the volume adjuster are user friendly, durable, hardly prone to errors, miniaturizable and energy-saving. The adjuster includes a manually-actuatable pushbutton switch and an infrared sensor for acquiring orientation and/or position of a manual movement carried out for the actuation. The infrared sensor is only activated while the pushbutton switch is actuated and/or during a restricted time period following that actuation. The hearing aid with the adjuster includes standard sensors as an infrared sensor and as a pushbutton switch. The infrared sensor permits construction of the adjuster without moveable mechanical actuating elements and avoids touch surfaces or contact surfaces susceptible to wear-and-tear. The increased energy consumption of an infrared sensor is counteracted by the functional combination with the pushbutton switch. The infrared sensor is only active when the pushbutton switch is actuated and is otherwise in idle mode.

### CROSS-REFERENCE TO RELATED APPLICATION

This application claims the priority, under 35 U.S.C. §119, of German Patent Application DE 10 2009 033 448.3, filed Jul. 16, 2009; the prior application is herewith incorporated by reference in its entirety.

### BACKGROUND OF THE INVENTION

Field of the Invention

The invention relates to a hearing aid with a volume adjuster and a volume adjuster for a hearing aid.

Hearing aids are used to compensate for a loss of hearing in the hard of hearing. So-called behind-the-ear instruments are known, which are formed of an ear mold worn in the ear and a housing worn behind the ear. The housing contains electrical components required for implementing a hearing aid function. Furthermore, in-the-ear instruments are known that merely are formed of a part that is worn in the ear and contains the electrical components. Other structures that are not mentioned herein are also known. Additionally, hearing aids can be constructed for tinnitus treatment. So-called tinnitus maskers are known, inter alia, and are used to suppress tinnitus hearing disorders. The term hearing aid as used hereinbelow should be understood to mean all of the aforementioned instruments.

Known hearing aids have pushbuttons, switches, sliding controllers and the like that can be used to change the volume of the hearing aid and are provided for adjusting further parameters of the hearing aid. A problem with such mechanical switching and adjusting elements is their susceptibility and sensitivity to wear-and-tear and contamination phenomena. A further problem with such elements resides in the fact that they have components that can be moved by manual actuation and pass through the housing of the hearing aid. Moveable components can only be sealed comparatively poorly with respect to the housing. They are therefore complex and can cause water and dirt permeable leaks in the housing.

U.S. Pat. No. 5,341,433 has disclosed a hearing aid with a housing and electronic components disposed therein, such as microphone, amplifier, receiver, current source, on/off switch and adjustment elements, for example a volume adjuster, in which provision is made for the use of pressure and position sensors constructed like a film. The pressure and position sensors are formed of polymer layers laminated together, wherein one layer is coated with interdigital electrodes, the associated other layer is coated by a semiconductor material and the sensors are disposed on the outside of the housing or in the housing wall. The sensors react to touch or pressure with variable electrical resistance. They are constructed as switches and/or actuators. They cannot be operated contactlessly and are therefore subjected to a certain amount of wear-and-tear as a result of the actuation thereof.

U.S. Patent Application Publication No. US 2005/0238190 A1 discloses a hearing aid constructed as a completely in canal (CIC) instrument to be worn within the auditory canal. A problem with such hearing aid instruments resides in the fact that the free and accessible housing side, on which operating elements such as on/off switch and volume adjuster have to be disposed, has a relatively small area. In view of the small area, it is difficult, in particular, to place adjustment configurations such as the volume adjuster, especially because they require a certain minimum dimension in order to be operable. It is therefore proposed to use an adjustment configuration or an operating element that is actuated without contact by movements of the hand in the direct vicinity of the hearing aid. The adjustment configuration can include an infrared sensor, an ultrasound sensor, or an inductive or capacitive proximity sensor. A problem therewith lies in the energy consumption of such sensors, which significantly reduces the lifespan of the energy supply, generally a battery or a rechargeable battery, of the hearing aid.

German Published, Non-Prosecuted Patent Application DE 10 2005 044 416 A1 has likewise disclosed a hearing aid in which the volume adjuster or the program-selection switch is constructed without moveable parts. By way of example, they can be based on an optical image sensor or an infrared sensor. European Patent Application EP 2 061 276 A1, corresponding to U.S. Patent Application Publication No. US 2009/0123013, also discloses a hearing aid with similar operating elements based on e.g. an infrared sensor.

The hearing aids disclosed previously with contactless or non-mechanical operating elements each have an increased energy consumption due to the sensors or sensor principles being utilized.

### SUMMARY OF THE INVENTION

It is accordingly an object of the invention to provide a volume adjuster for a hearing aid and a hearing aid with such a volume adjuster, which overcome the hereinafore-mentioned disadvantages of the heretofore-known devices of this general type and which are user friendly, durable, hardly prone to errors, miniaturizable and use little energy.

With the foregoing and other objects in view there is provided, in accordance with the invention, a manually actuatable volume adjuster for a hearing aid. The volume adjuster comprises a manually-actuatable pushbutton switch and an infrared sensor configured to acquire an orientation and/or a position of a manual movement carried out for an actuation. The infrared sensor is configured to be activated only while the pushbutton switch is actuated and/or during a restricted time period following an actuation of the pushbutton switch.

If activation is provided for following an actuation, provision is made for the time of the activation period to be restricted to at most 1.5 seconds, preferably to 0.8 seconds. A further basic concept of the invention resides in a hearing aid with such a volume adjuster.

A currently available, standard sensor operating in a wavelength spectrum between 780 nm and 1,000,000 nm can be used as an infrared sensor. In one embodiment variant, use can be made of an infrared sensor in the so-called near infrared wavelength spectrum between 780 nm and 1,400 nm. In a further embodiment variant, use can be made of an infrared sensor in the so-called photographic or colored infrared wavelength spectrum between 780 nm and 1,000 nm. Further embodiment variants are possible.

A currently available, standard sensor can be used as a pushbutton switch. In one embodiment variant, the sensor can be based on a sensor element on a metal-coated, piezoelectric PVDF film. In a further embodiment variant, the sensor can be based on a sensor element made of a resistive film. In a further embodiment variant, the sensor can be based on a sensor element made of a piezoresistive pressure sensor. In a further embodiment variant, the sensor can be based on a sensor element made of a piezoelectric pressure sensor. In a further embodiment variant, the sensor can be based on a sensor element on a capacitive polymer pressure sensor. Further embodiment variants are possible. In one embodiment variant, the pushbutton switch can be constructed as a film or layer with layer thicknesses between 0.5 and 2 mm.

The use of an infrared sensor affords the possibility of constructing the volume adjuster without moveable mechanical actuating elements and avoiding, as far as possible, touch surfaces or contact surfaces susceptible to wear-and-tear. The increased energy consumption of an infrared sensor is counteracted by the functional combination with the pushbutton switch. The infrared sensor is only active when the pushbutton switch is actuated and is otherwise in the idle mode. The idle mode can either be a consumption-minimized operating mode, comparable to a standby function or the infrared sensor can be completely switched off in the idle mode and then requires no energy at all. This can be achieved by virtue of the fact that the pushbutton switch shuts down or interrupts the energy supply of the infrared sensor and only closes the energy supply during the actuation.

What should additionally be taken into account is that the pushbutton switch itself should likewise consume little or no energy while it is not actuated. Since the pushbutton switch can also advantageously be constructed without moveable mechanical elements, a sensor structure with low energy consumption should be selected where appropriate. A reduction in the overall energy consumption of the operating elements of the hearing aid can also be achieved by virtue of the fact that the pushbutton switch activates not only the volume adjuster, but also a plurality of operating elements that have a relatively high energy consumption in the activated state but are otherwise deactivated. This reduces the number of energy-consuming components to the pushbutton switch, provided the latter is not actuated, and only when the pushbutton switch is actuated is the number of energy-consuming components expanded to all operating elements that are activated by the actuation.

In accordance with another advantageous feature of the invention, the pushbutton switch in the non-actuated state has a lower energy consumption than the infrared sensor in the activated state.

If the pushbutton switch in the active but non-actuated state has a lower energy consumption than the infrared sensor, the combination of the pushbutton switch and the infrared sensor already achieves a reduction in the energy consumption and hence an increased battery life is ensured.

In accordance with a further advantageous feature of the invention, the pushbutton switch has a planiform structure, is formed of a material at least partly transparent to infrared radiation and covers the infrared sensor.

Placing the pushbutton switch over the infrared sensor simplifies the operation because the activation by the pushbuttons and the adjustment of the volume can be carried out on one and the same operating element by targeted movement or positioning of the hand or a finger. Moreover, this is advantageous for the miniaturization of the combination of the pushbutton switch and the infrared sensor. This can achieve a further miniaturization of the hearing aid for which the adjuster is provided.

In accordance with an added advantageous feature of the invention, the volume adjuster includes a manually-actuatable mechanical adjusting knob, more particularly a rotary knob or a sliding button, and the infrared sensor is constructed to acquire an orientation and/or a position of the adjusting knob.

An advantage of a manually-actuatable adjusting knob is that a user obtains a tactile response during the adjustment because the mechanical adjustment can be felt. This increases the user friendliness. Furthermore, many hearing aid wearers are used to mechanical operating elements and therefore do not have to get used to a new operating concept. Moreover, a mechanical operating element can also reduce the susceptibility to errors because inadvertent adjustment, e.g. by inadvertently touching the adjuster when handling the hearing aid, may occur less easily than inadvertent adjustment of a volume adjuster operating through the use of an infrared sensor.

In accordance with an additional advantageous feature of the invention, the adjusting knob is additionally able to be actuated by pushbuttons, and the pushbutton switch is integrated into the adjusting knob.

The mutual integration of the adjusting knob and the pushbutton switch simplifies the operation because merely one operating element has to be actuated. Additionally, it contributes to the miniaturization of the volume adjuster, and hence also to the miniaturization of the hearing aid for which the adjuster is provided.

With the objects of the invention in view, there is also provided a hearing aid, comprising a volume adjuster according to the invention.

In accordance with an advantageous concomitant feature of the invention, the hearing aid includes a housing and the infrared sensor and the pushbutton switch are disposed in the housing in such a way that no component that is moved by manual actuation passes through the housing.

The proposed combination of an infrared sensor with a pushbutton switch firstly brings about a reduced energy consumption, as explained above, and thereby contributes to increasing the service life of the energy supply. Secondly, it allows a structure of the volume adjuster that can be incorporated into the housing in a fixed and unmovable fashion. This avoids leaks or an increased sealing complexity when sealing movable parts with respect to the housing. By avoiding moving components that pass through the housing, it is possible to achieve a completely waterproof, dirt-proof and even gas-tight housing in the vicinity of the volume adjuster.

Other features which are considered as characteristic for the invention are set forth in the appended claims.

Although the invention is illustrated and described herein as embodied in a volume adjuster and a hearing aid with a volume adjuster, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a longitudinal-sectional view of a hearing aid with a volume adjuster;

FIG. 2 is an enlarged, fragmentary, longitudinal-sectional view of a volume adjuster with an infrared sensor and a pushbutton; and

FIG. 3 is a view similar to FIG. 2 showing a mechanical volume adjuster with an infrared sensor and a pushbutton.

### DETAILED DESCRIPTION OF THE INVENTION

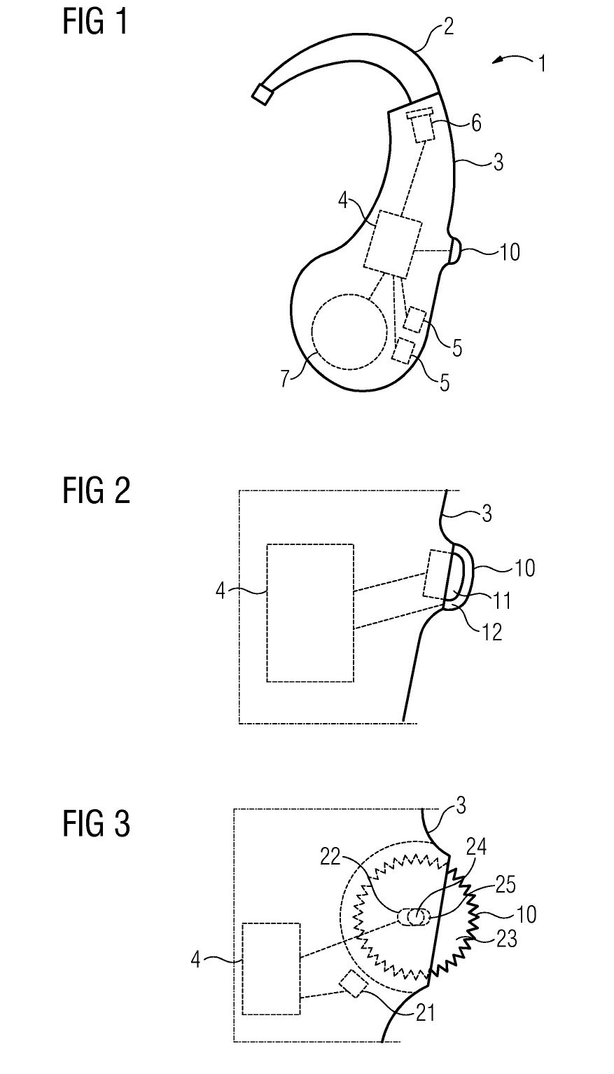

Referring now to the figures of the drawings in detail and first, particularly, to FIG. 1 thereof, there is seen a diagrammatically illustrated hearing aid 1 with a behind-the-ear structure. A tone hook 2 is used to hook the hearing aid 1 onto or behind the ear. The tone hook 2 is connected to a housing 3 and carries the latter. Electronic components for signal processing and generation are disposed within the housing 3.

An end of the tone hook 2, opposite the housing 3, has a non-illustrated sound output opening through which sound is transmitted into a similarly non-illustrated hearing tube that leads to the auditory canal of the hearing aid wearer. Surrounding signals or other acoustic signals, which are processed and amplified by the hearing aid 1, are transmitted to the ear of the hearing aid wearer through the use of the above-described path passing through the tone hook 2 and the sound tube.

A signal processing configuration 4, which is used to process and generate acoustic signals corresponding to the required treatment for the hearing aid wearer, is located in the housing 3. Surrounding signals are recorded by one or more microphones 5 and are transmitted to the signal processing configuration 4 as an input signal. The signal processing configuration 4 processes and amplifies the surrounding signals and transmits a signal generated in this fashion to a receiver 6 (which is the conventional expression for an earpiece or loudspeaker in hearing aid technology). A battery 7 is used for supplying the electronic components of the hearing aid 1 with energy. The battery 7 can be constructed as a single-use battery, which has to be replaced as soon as it has been exhausted. It can also be constructed as a rechargeable battery, which has to be recharged as soon as it has been exhausted, either in the hearing aid 1 or in a charging instrument provided therefor.

As explained above, the hearing aid 1 is used either for generating an acoustic signal for tinnitus treatment or for processing and amplifying acoustic surrounding signals for treating the hard of hearing. An output signal of the hearing aid 1, which is a signal generated by the receiver 6, can be modified in terms of volume. Changes in volume can firstly be undertaken by the signal processing configuration 4. Secondly, a change can be undertaken by the hearing aid wearer or by an operating person, namely by actuating a volume adjuster 10. The volume adjuster 10 includes an infrared sensor and a pushbutton switch, and will be explained in more detail below.

FIG. 2 diagrammatically reproduces the previously shown volume adjuster 10 in an enlarged illustration. The volume adjuster 10 is incorporated into the housing 3 and electrically connected to the signal processing configuration 4. The connection is intended to be indicated by dashed lines. The volume adjuster 10 includes an infrared sensor 11. The infrared sensor 11 allows the detection or acquisition of radiation in the infrared wavelength spectrum. It is constructed in such a way that it allows at least one one-dimensional acquisition, i.e. the acquisition of infrared signals along an elongate measurement region. An embodiment of the infrared sensor 11 for the acquisition of a three-dimensional measurement field, i.e. a construction as an infrared image sensor, is likewise feasible. Since the human body radiates heat, the infrared sensor 11 can acquire, in particular, from the human body or a hand or a finger. The sensor 11 can use the at least one-dimensional, possibly two-dimensional, measurement field to be able to detect movement within the measurement field, or to detect the approach of a finger or a hand in a certain region of the measurement field. The volume can be changed by manual actuation as a function of such a detection, by undertaking a hand movement either in a certain direction or to a certain location on the hearing aid 1. For example, an upward hand movement can be used to increase the volume and a downward hand movement can be used to decrease the volume. Further movement schemes, e.g. to the right or left, are likewise feasible. If it is merely the hand approaching a certain point on the hearing aid that should be used to adjust the volume, then approaching the upper part of the hearing aid 1 could, for example, lead to an increase in the volume and approaching the lower part could lead to a reduction in the volume.

The infrared sensor 11 transmits the acquired infrared signals as an input signal to the signal processing configuration 4, which undertakes appropriate signal processing and accordingly adjusts the amplification of the signals transmitted to the receiver 6.

The infrared sensor 11 is covered by a planiform pushbutton switch 12. The pushbutton switch 12 generates an output signal when touched manually, i.e. when pushed. As long as the pushbutton switch 12 remains untouched, it does not generate an active output signal. The pushbutton switch 12 is connected to the signal processing configuration 4, to which the touch signal is transmitted as an input signal. The signal processing configuration 4 controls the energy supply for the infrared sensor 11 in such a way that the latter is switched off in an idle mode as long as the pushbutton switch 12 has not been actuated. It is for this reason that the infrared sensor 11 is not supplied with energy in the idle mode, and this contributes to the reduction in energy consumption and increases the service life of the battery 7.

As soon as the pushbutton switch 12 is actuated by touch, the energy supply of the infrared sensor 11 is activated by the signal processing configuration 4 and hence the infrared sensor is switched on. In this case, the infrared sensor 11 can be switched on only while the pushbutton switch 12 is actuated and/or during a restricted time period following an actuation. If activation is provided for following an actuation, provision is made for the time of the activation period to be restricted to at most 1.5 seconds, preferably to 0.8 seconds. As a result of this, the infrared sensor 11 only is active, consumes energy and can be actuated, while the pushbutton switch 12 is actuated. An adjustment of the volume therefore presupposes that the pushbutton switch 12 is actuated and the manual movement required for adjusting the volume is carried out at the same time.

The pushbutton switch 12 is transparent to infrared radiation and therefore infrared detection through the use of the infrared sensor 11 located therebelow is possible. By way of example, the switch can be constructed as a pressure-sensitive electrically active polymer film. It can also be constructed as a resistive sensor that detects changes in conductivity due to manual touch as a result of the specific conductivity of human skin. Furthermore, capacitive, inductive or mechanical sensor principles are feasible for the pushbutton switch 12.

The volume adjuster 10 does not include any moveable parts because neither the infrared sensor 11 nor the pushbutton switch 12 has to be moved at all for actuation. They can therefore be incorporated into the housing 3 in a flush fashion. By way of example, the planiform pushbutton switch 12 can be adhesively bonded to the housing in a sealed fashion, or it can be integrated into the housing. Avoiding moveable parts allows the housing 3 and volume adjuster 10 or pushbutton switch to be integrated or adhesively bonded together in a sealed fashion or connected together in any other sealed fashion, which can be constructed to be completely waterproof, dirt-proof and even gas-tight. This significantly increases the resistance of the hearing aid 1 against the effects of weather and the surroundings.

FIG. 3 illustrates a different embodiment of the volume adjuster 10, likewise in an enlarged diagrammatic fashion. Provision is made in the embodiment of FIG. 3 for a mechanically moveable adjusting knob 23 in the housing 3. The adjusting knob 23 resembles a thumbwheel, i.e. a rotary knob, and can rotate around an axle or shaft 24. Manual actuation is brought about by rotating the rotary knob 23. The axle or shaft 24 is mounted in a slot 25 in a rotatable and displaceable fashion. The slot 25 and the axle or shaft 24 are disposed in such a way that they are located completely outside of the interior region of the housing 3. In particular, the moveable axle or shaft 24 does not pass through the housing 3 and therefore a seal for moveable parts with respect to the housing 3 is avoided.

The slot 25 enables a linear movement of the axle or shaft 24, and hence the rotary knob 23, along the length of the slot. A pushbutton switch 22 is disposed on a base of the slot 25. The pushbutton switch is actuated by pressure on the rotary knob 23, with the axle or shaft 24 being pushed onto the pushbutton switch 22 in the process. The pushbutton switch 22 is connected to the signal processing configuration 4 through an electrical connection indicated by dashed lines. The pushbutton switch 22 is connected or adhesively bonded to the housing 3 in a fashion comparable to the preceding explanations, in such a way that it is closed off in a waterproof and dirt-proof fashion and, depending on the structure, even in a gas-tight fashion.

A rotary movement of the rotary knob 23 is detected by an appropriately disposed infrared sensor 21. The rotary knob 23 has appropriate structuring or markings that can be observed in the infrared wavelength spectrum, but are not illustrated in the figure, so that it can be detected by the infrared sensor 21. In this case, the infrared sensor 21 is disposed completely within the interior region of the housing 3 and the rotary knob 23 is disposed completely outside thereof. The infrared sensor 21 therefore detects a movement of the rotary knob 23 through the wall of the housing 3, which for this purpose has a structure in the region of the infrared sensor 21 that is transparent to radiation in the infrared wavelength spectrum.

The structure of the volume adjuster 10 explained herein therefore allows a completely waterproof and dirt-proof, possibly even gas-tight, incorporation into the housing 3 because no moveable parts of the adjuster pass through the housing. Furthermore, the integration of the pushbutton switch 22 and the rotary knob 23 with the axle or shaft 24 is advantageous for the miniaturization of the volume adjuster 10. As explained above, the pushbutton switch 22 has to be actuated for the signal processing configuration 4 to supply the infrared sensor 21 with energy. As long as the pushbutton switch 22 has not yet been actuated, the infrared sensor 21 is switched off by the signal processing configuration 4 and then consumes no energy.

One basic concept of the invention can be summarized as follows: The invention relates to a hearing aid with a volume adjuster and a volume adjuster for a hearing aid. The object of the invention resides in specifying a volume adjuster for a hearing aid and a hearing aid with such a volume adjuster, which is user friendly, durable, hardly prone to errors, miniaturizable and uses little energy. Another basic concept of the invention resides in a volume adjuster for a hearing aid, which volume adjuster can be actuated manually and includes an infrared sensor, wherein the infrared sensor is constructed to acquire an orientation and/or a position of a manual movement carried out for the actuation, wherein, furthermore, a manually-actuatable pushbutton switch is included and wherein the infrared sensor is only activated while the pushbutton switch is actuated and/or during a restricted time period following an actuation of the pushbutton switch. A further basic concept of the invention resides in a hearing aid with such a volume adjuster. Standard sensors can be used as the infrared sensor and as the pushbutton switch. The use of an infrared sensor affords the possibility of constructing the volume adjuster without moveable mechanical actuating elements and avoiding touch surfaces or contact surfaces susceptible to wear-and-tear, as far as possible. The increased energy consumption of an infrared sensor is counteracted by the functional combination with the pushbutton switch. The infrared sensor is only active when the pushbutton switch is actuated and is otherwise in the idle mode.

1. A manually actuatable volume adjuster for a hearing aid, the volume adjuster comprising:
a manually-actuatable pushbutton switch; and
an infrared sensor configured to acquire an orientation and/or a position of a manual movement carried out for an actuation;
said infrared sensor configured to be activated only while said pushbutton switch is actuated and/or during a restricted time period following an actuation of said pushbutton switch.

2. The volume adjuster according to claim 1, wherein said pushbutton switch has a lower energy consumption in a non-actuated state than said infrared sensor in an activated state.

3. The volume adjuster according to claim 1, wherein said infrared sensor and said pushbutton switch are integrated into a common operating element.

4. The volume adjuster according to claim 1, wherein said pushbutton switch has a planiform structure, is formed of a material at least partly being transparent to infrared radiation and covers said infrared sensor.

5. The volume adjuster according to claim 1, which further comprises a manually-actuatable mechanical adjusting knob, said infrared sensor being configured to acquire an orientation and/or a position of said adjusting knob.

6. The volume adjuster according to claim 5, wherein said mechanical adjusting knob is a rotary knob or a sliding button.

7. The volume adjuster according to claim 5, wherein said adjusting knob is additionally actuatable by pushbuttons, and said pushbutton switch is integrated into said adjusting knob.

8. A hearing aid, comprising:
a volume adjuster according to claim 1.

9. The hearing aid according to claim 8, which further comprises a housing, said infrared sensor and said pushbutton switch being disposed in said housing, and said housing having no component moved by manual actuation passing through said housing.
